(19) United States
(12) Patent Application Publication
(10) Pub. No.: US 2025/0392091 A1
(43) Pub. Date: Dec. 25, 2025

(54) CRIMPING DEVICE AND CRIMPING SYSTEM

(71) Applicant: Tyco Electronics (Shanghai) Co., Ltd., Shanghai (CN)

(72) Inventor: Shen Zhang, Shanghai (CN)

(73) Assignee: Tyco Electronics (Shanghai) Co., Ltd., Shanghai (CN)

(21) Appl. No.: 19/247,009

(22) Filed: Jun. 24, 2025

(30) Foreign Application Priority Data
Jun. 24, 2024 (CN) 202410825279.0

(51) Int. Cl. H01R 43/052; H01R 4/18

(52) U.S. Cl. CPC H01R 43/052; H01R 4/182

(57) ABSTRACT

A crimping device includes an upper moving mechanism, a lower moving mechanism located below the upper moving mechanism, an upper crimping module installed on the upper moving mechanism, a lower crimping module located below the upper moving mechanism and installed on the lower moving mechanism, and a carrier support frame for supporting a carrier transported to the crimping device and a flexible flat piece loaded on the carrier. The upper crimping module and the lower crimping module are adapted to crimp a terminal onto the flexible flat piece. The upper moving mechanism and the lower moving mechanism are adapted to horizontally move the upper crimping module and the lower crimping module respectively, so that the upper crimping module and the lower crimping module are synchronously movable to any crimping position on the flexible flat piece.

### CROSS-REFERENCE TO RELATED APPLICATION

This application claims the benefit of Chinese Patent Application No. CN202410825279.0 filed on Jun. 24, 2024, in the State Intellectual Property Office of China, the whole disclosure of which is incorporated herein by reference.

### FIELD OF THE INVENTION

The present disclosure relates to a crimping device and a crimping system comprising the crimping device, particularly to a crimping device and crimping system for crimping terminals onto a flexible printed circuit or a flexible flat cable.

### BACKGROUND OF THE INVENTION

In the prior art, a crimping device used to crimp terminals onto Flexible Printed Circuit (FPC) or Flexible Flat Cable (FFC) typically includes a frame, an upper crimping module, and a lower crimping module. The upper and lower crimping modules are installed on the frame to crimp terminals onto the flexible printed circuit or the flexible flat cable. In the prior art, the upper and lower crimping modules cannot move horizontally, therefore, they cannot be moved to any crimping position on the flexible circuit board or flexible flat cable. In addition, in the prior art, the frame of the crimping device interferes with the transport carrier that transports the flexible printed circuit or the flexible flat cable, which results in the transport carrier being unable to be moved into the crimping device. Therefore, in the prior art, it is necessary to remove the flexible printed circuit or the flexible flat cable from the transport carrier and place it on the support seat of the lower crimping module. After completing the terminal crimping, reloading the flexible printed circuit or the flexible flat cable with terminals already crimped onto the conveyor carrier reduces production efficiency. Moreover, the existing crimping device has the problems of large volume and high cost.

### SUMMARY OF THE INVENTION

According to an embodiment of the present disclosure, a crimping device includes an upper moving mechanism, a lower moving mechanism located below the upper moving mechanism, an upper crimping module installed on the upper moving mechanism, a lower crimping module located below the upper moving mechanism and installed on the lower moving mechanism, and a carrier support frame for supporting a carrier transported to the crimping device and a flexible flat piece loaded on the carrier. The upper crimping module and the lower crimping module are adapted to crimp a terminal onto the flexible flat piece. The upper moving mechanism and the lower moving mechanism are adapted to horizontally move the upper crimping module and the lower crimping module respectively, so that the upper crimping module and the lower crimping module are synchronously movable to any crimping position on the flexible flat piece.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a crimping device according to an exemplary embodiment of the present invention;

FIG. 2 shows an illustrative perspective view of a crimping device according to an exemplary embodiment of the present invention, wherein the conveyed carrier is shown;

FIG. 3 shows an illustrative perspective view of a crimping device according to an exemplary embodiment of the present invention, wherein the carrier transported into the crimping device is shown;

FIG. 4 shows an illustrative plan view of a crimping device according to an exemplary embodiment of the present invention when viewed from the front side;

FIG. 5 shows an illustrative exploded view of a crimping device according to an exemplary embodiment of the present invention;

FIG. 6 shows an illustrative perspective view of the upper moving module of the crimping device according to an exemplary embodiment of the present invention;

FIG. 7 shows an illustrative exploded view of the upper moving module of the crimping device according to an exemplary embodiment of the present invention;

FIG. 8 shows an illustrative exploded view of the upper moving module and upper crimping module of the crimping device according to an exemplary embodiment of the present invention;

FIG. 9 shows an illustrative perspective view of the lower moving module of the crimping device according to an exemplary embodiment of the present invention;

FIG. 10 shows an illustrative exploded view of the lower moving module of the crimping device according to an exemplary embodiment of the present invention; and

FIG. 11 shows an illustrative exploded view of the lower moving module and the lower crimping module of the crimping device according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a crimping device comprises: an upper moving mechanism; a lower moving mechanism located below the upper moving mechanism; an upper crimping module installed on the upper moving mechanism to move together with the upper moving mechanism; a lower crimping module located below the upper moving mechanism and installed on the lower moving mechanism to move together with the lower moving mechanism; and a carrier support frame for supporting a carrier transported to the crimping device and a flexible flat piece loaded on the carrier. The upper crimping module and the lower crimping module are adapted to crimp a terminal onto the flexible flat piece. The upper moving mechanism and the lower moving mechanism are used to horizontally move the upper crimping module and the lower crimping module respectively, so that the upper crimping module and the lower crimping module can be synchronously moved to any crimping position on the flexible flat piece.

According to another embodiment, a crimping system comprises: the above crimping device; a carrier for loading a flexible flat piece; and a carrier conveying mechanism for conveying the carrier loaded with the flexible flat piece to the crimping device. The upper crimping module and lower crimping module of the crimping device are used to crimp a terminal onto the flexible flat piece.

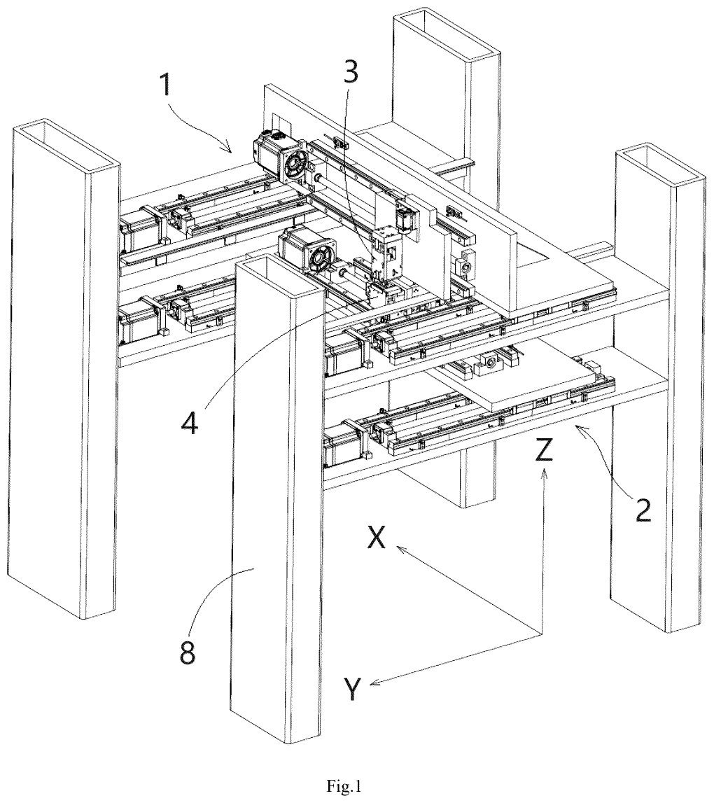

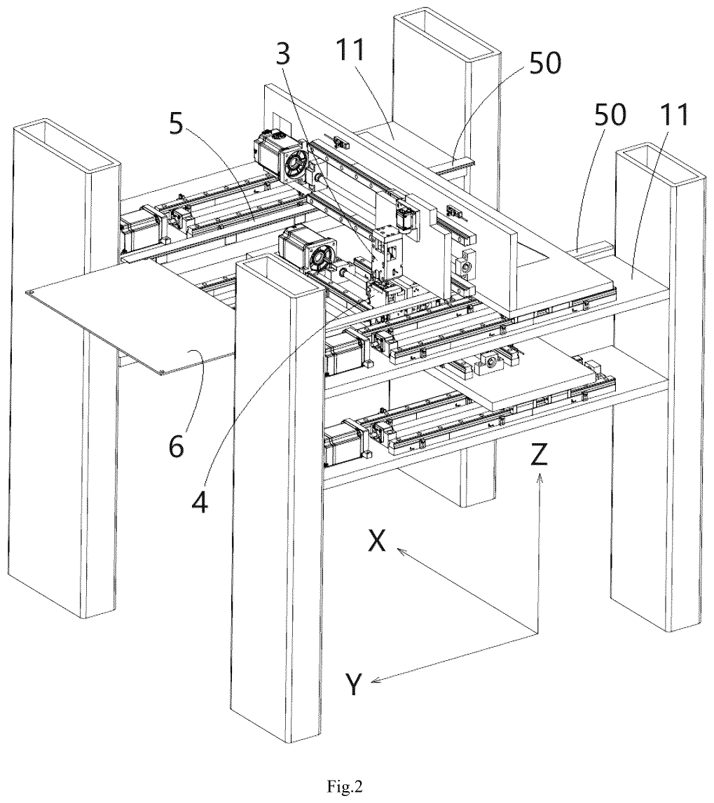

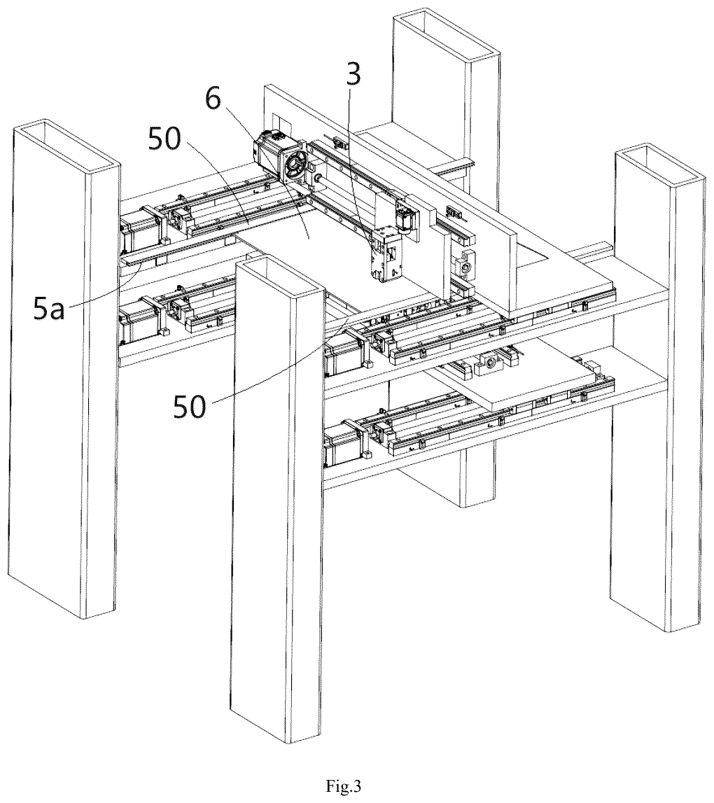

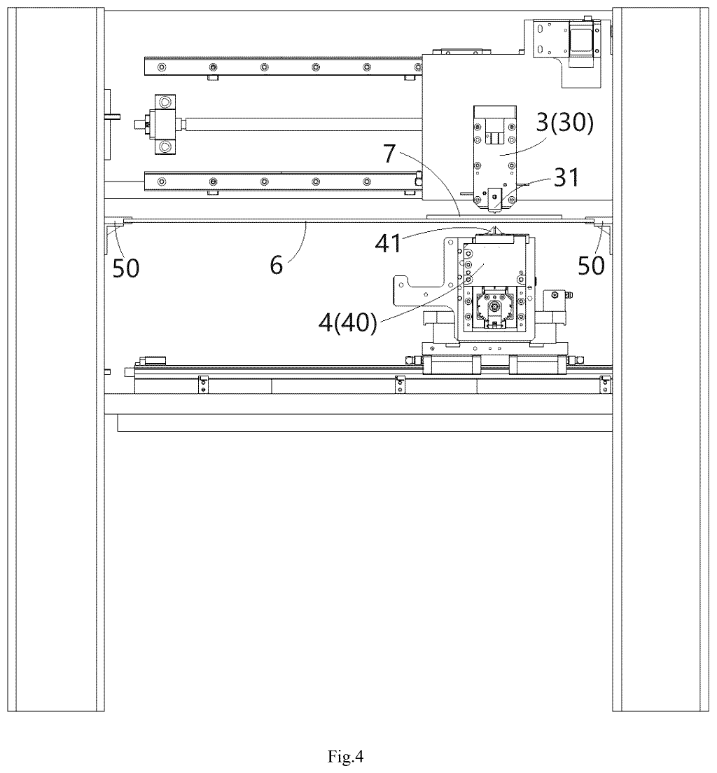

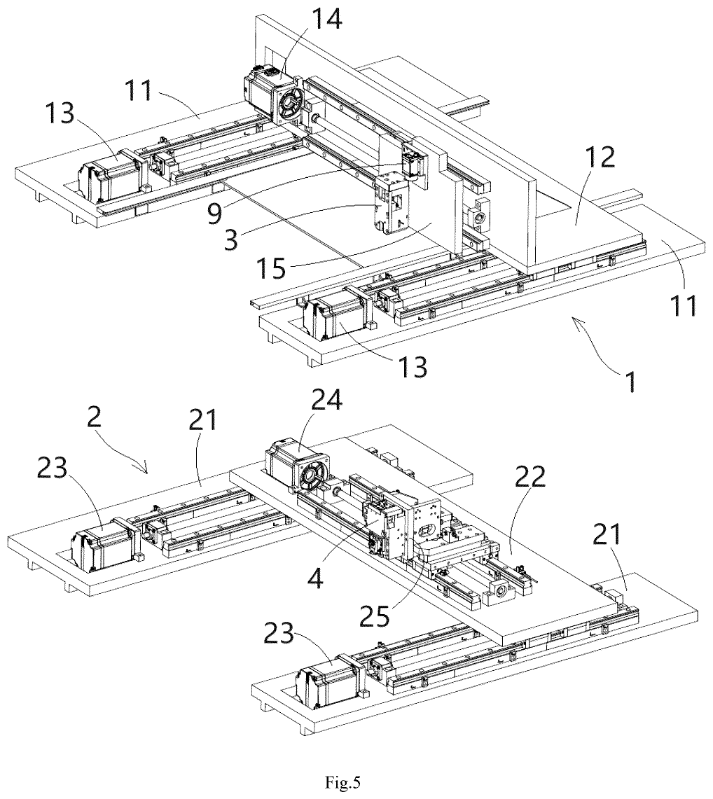

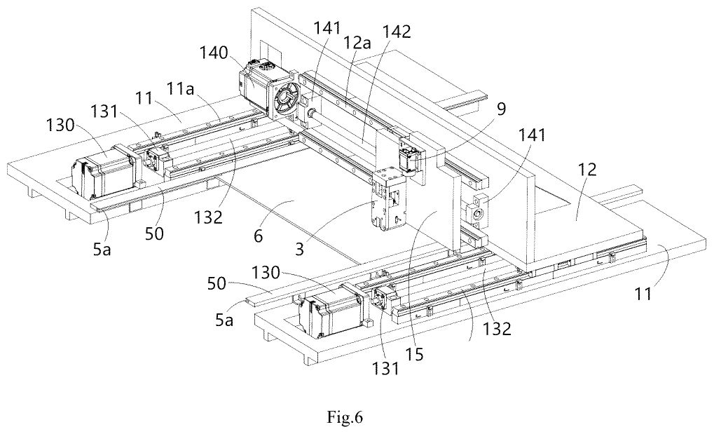

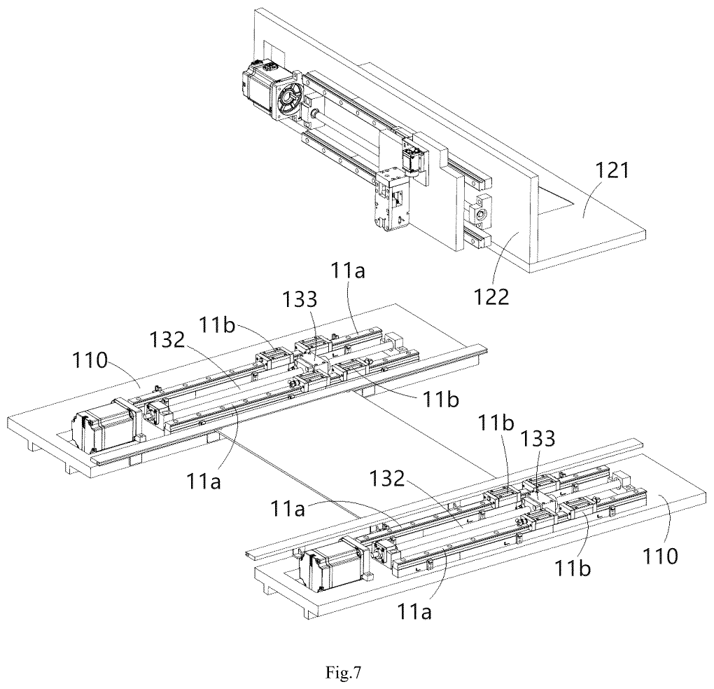

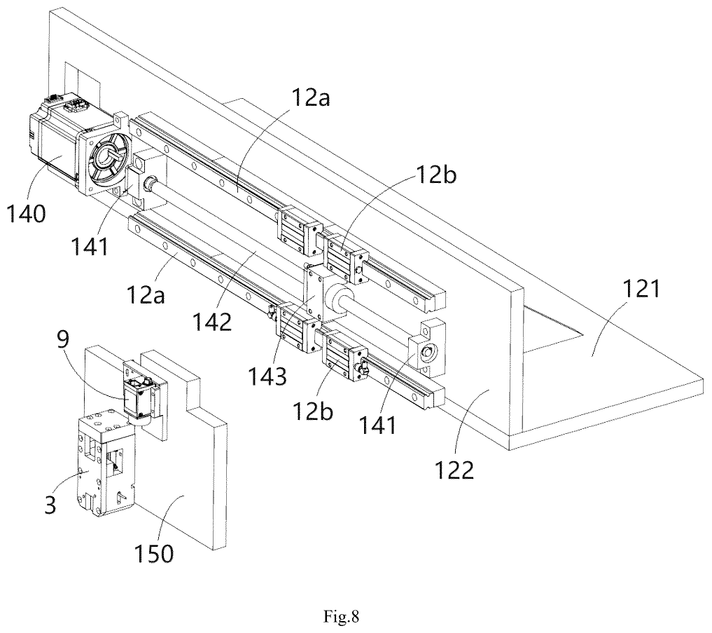

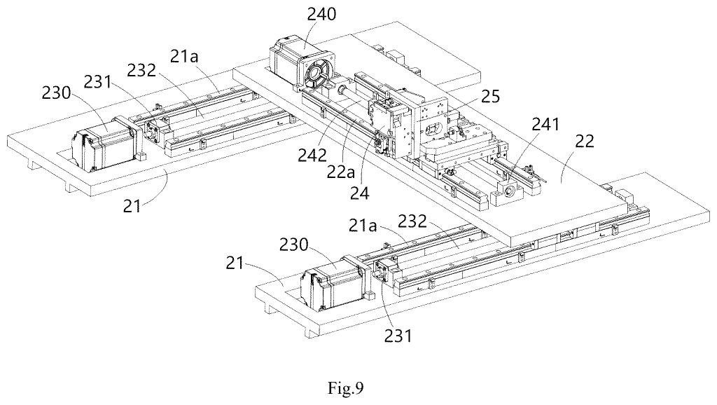

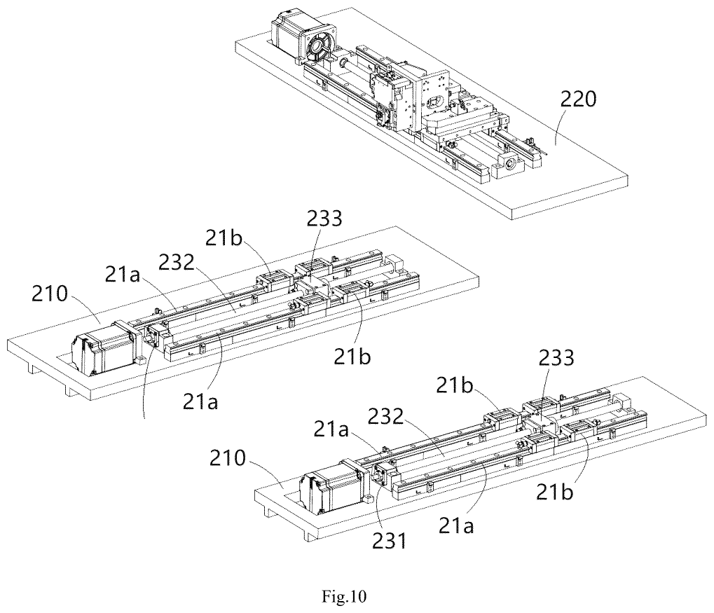

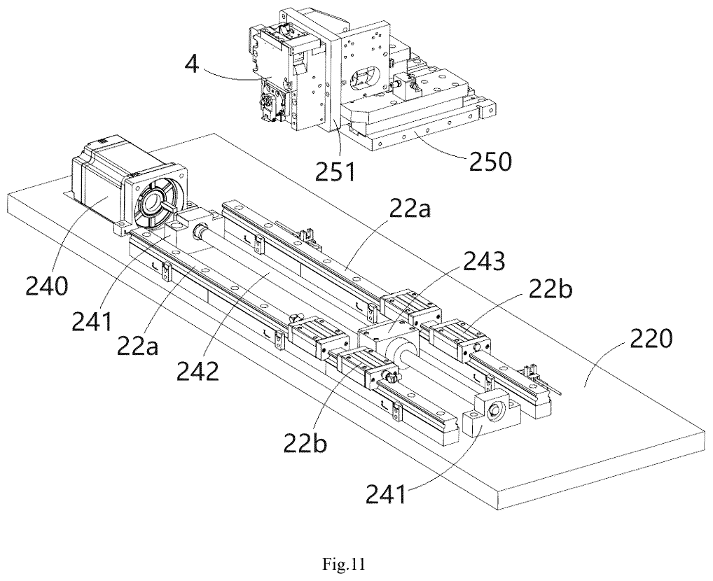

FIG. 1 shows an illustrative perspective view of a crimping device according to an exemplary embodiment of the present invention. FIG. 2 shows an illustrative perspective view of a crimping device according to an exemplary embodiment of the present invention, wherein the conveyed carrier 6 is shown. FIG. 3 shows an illustrative perspective view of a crimping device according to an exemplary embodiment of the present invention, in which a carrier 6 is conveyed into the crimping device. FIG. 4 shows an illustrative plan view of a crimping device according to an exemplary embodiment of the present invention when viewed from the front side. FIG. 5 shows an illustrative exploded view of a crimping device according to an exemplary embodiment of the present invention. FIG. 6 shows an illustrative perspective view of the upper moving module 1 of the crimping device according to an exemplary embodiment of the present invention. FIG. 7 shows an illustrative exploded view of the upper moving module 1 of the crimping device according to an exemplary embodiment of the present invention. FIG. 8 shows an illustrative exploded view of the upper moving module 1 and the upper crimping module 3 of the crimping device according to an exemplary embodiment of the present invention. FIG. 9 shows an illustrative perspective view of the lower moving module 2 of the crimping device according to an exemplary embodiment of the present invention. FIG. 10 shows an illustrative exploded view of the lower moving module 2 of the crimping device according to an exemplary embodiment of the present invention. FIG. 11 shows an illustrative exploded view of the lower moving module 2 and the lower crimping module 4 of the crimping device according to an exemplary embodiment of the present invention.

As shown in FIGS. 1-11, in an exemplary embodiment of the present invention, an online crimping device is disclosed to improve crimping efficiency. The crimping device includes an upper moving mechanism 1, a lower moving mechanism 2, an upper crimping module 3, a lower crimping module 4, and a carrier support frame 5. The lower moving mechanism 2 is located below the upper moving mechanism 1. The upper crimping module 3 is mounted onto the upper moving mechanism 1 to move together with it. The lower crimping module 4 is located below the upper moving mechanism 1 and installed on the lower moving mechanism 2 to move together with the lower moving mechanism 2. The carrier support frame 5 is used to support a carrier 6 transported to the crimping device and a flexible flat piece 7 loaded on the carrier 6. The upper crimping module 3 and the lower crimping module 4 are used to crimp a terminal (not shown) onto the flexible flat piece 7. The upper moving mechanism 1 and the lower moving mechanism 2 are used to horizontally move the upper crimping module 3 and the lower crimping module 4, respectively, so that they can be synchronously moved to any crimping position on the flexible flat piece 7. In the illustrated embodiment, the flexible flat piece 7 can be a flexible printed circuit or a flexible flat cable.

In the illustrated embodiment, the upper moving mechanism 1 includes a pair of upper longitudinal beams 11, an upper transverse beam 12, and an upper mounting bracket 15. The pair of longitudinal beams 11 extend along the longitudinal direction Y and are spaced opposite each other in a transverse direction X perpendicular to the longitudinal direction Y. The two ends of the upper transverse beam 12 are respectively mounted on the pair of upper longitudinal beams 11 in a movable manner, and can move along the longitudinal direction Y relative to the upper longitudinal beams 11. The upper mounting bracket 15 is mounted on the upper transverse beam 12 in a movable manner and can move along the transverse direction X relative to the upper transverse beam 12. The upper crimping module 3 is installed on the upper mounting bracket 15, so that the upper crimping module 3 can move along the longitudinal direction Y and the transverse direction X.

The upper moving mechanism 1 further comprises two pairs of upper longitudinal sliding rails 11a and multiple upper longitudinal sliders 11b. Two pairs of longitudinal sliding rails 11a extend along the longitudinal direction Y and are respectively fixed to the pair of longitudinal beams 11. Multiple upper longitudinal sliders 11b are slidably installed on two pairs of upper longitudinal rails 11a respectively, so as to be able to move along the upper longitudinal rails 11a. The two ends of the upper transverse beam 12 are respectively fixed to multiple upper longitudinal sliders 11b, so that the upper transverse beam 12 can move along the upper longitudinal sliding rail 11a together with the upper longitudinal sliders 11b.

The upper moving mechanism 1 further comprises a pair of upper longitudinal driving mechanisms 13, which are respectively installed on the pair of upper longitudinal beams 11 and connected to the upper transverse beam 12, for driving the upper transverse beam 12 to move along the longitudinal direction Y. The upper longitudinal driving mechanism 13 includes a pair of first support blocks 131, a first lead screw 132, a first nut 133, and a first servo motor 130. The pair of first support blocks 131 are fixed to the upper longitudinal beam 11. The two ends of the first lead screw 132 are respectively rotatably mounted on the pair of first support blocks 131. The first nut 133 is threaded with the first lead screw 132 and fixed to the upper transverse beam 12. The first servo motor 130 is installed on the upper longitudinal beam 11 and its output shaft is connected to one end of the first lead screw 132. When the first servo motor 130 drives the first lead screw 132 to rotate, the first lead screw 132 drives the first nut 133 and the upper transverse beam 12 to move along the longitudinal direction Y.

The upper moving mechanism 1 further comprises a pair of upper transverse sliding rails 12a and multiple upper transverse sliders 12b. The pair of upper transverse sliding rails 12a extend along the transverse direction X and are fixed to the upper transverse beam 12. Multiple upper transverse sliders 12b are slidably installed on the pair of upper transverse sliding rails 12a respectively, so as to be able to move along the upper transverse sliding rails 12a. The upper mounting bracket 15 is fixed to multiple upper transverse sliders 12b, allowing the upper mounting bracket 15 to move along the upper transverse slide rail 12a along with the upper transverse sliders 12b.

The upper longitudinal beam 11 includes an upper longitudinal horizontal plate 110. The upper longitudinal slide rail 11a, the upper longitudinal slider 11b, and the upper longitudinal driving mechanism 13 are installed on the upper longitudinal horizontal plate 110. The first lead screw 132 is located between the pair of upper longitudinal sliding rails 11a on the upper longitudinal horizontal plate 110.

The upper moving mechanism 1 further comprises an upper transverse driving mechanism 14, which is installed on the upper transverse beam 12 and connected to the upper mounting bracket 15, for driving the upper mounting bracket 15 to move along the transverse direction X.

The upper transverse driving mechanism 14 includes a pair of second support blocks 141, a second lead screw 142, a second nut 143, and a second servo motor 140. The pair of second support blocks 141 are fixed to the upper transverse beam 12. The two ends of the second lead screw 142 are respectively rotatably mounted on the pair of second support blocks 141. The second nut 143 is threaded with the second lead screw 142 and fixed to the upper mounting bracket 15. The second servo motor 140 is installed on the upper transverse beam 12 and its output shaft is connected to one end of the second lead screw 142. When the second servo motor 140 drives the second lead screw 142 to rotate, the second lead screw 142 drives the second nut 143 and the upper mounting bracket 15 to move together in the transverse direction X. However, the present invention is not limited to the illustrated embodiment. For example, in another exemplary embodiment of the present invention, the upper moving mechanism 1 and the lower moving mechanism 2 may be linear motors.

The upper transverse beam 12 includes an upper transverse horizontal plate 121 and an upper transverse vertical plate 122. The upper transverse horizontal plate 121 is fixed to the upper longitudinal slider 11b and the first nut 133. The upper horizontal vertical plate 122 is connected to one side of the upper transverse horizontal plate 121. The upper transverse sliding rail 12a, the upper transverse slider 12b, and the upper transverse driving mechanism 14 are installed on the upper transverse vertical plate 122, and the second lead screw 142 is located between the pair of upper transverse sliding rails 12a on the upper transverse vertical plate 122.

The upper mounting bracket 15 includes an upper vertical mounting plate 150, which is fixed to the upper transverse slider 12b and the second nut 143. The upper crimping module 3 is installed onto the upper vertical mounting plate 150.

The carrier support frame 5 includes a pair of support members 50, which extend along the longitudinal direction Y and are respectively fixed to the pair of upper longitudinal beams 11. A horizontal groove 5a extending along the longitudinal direction Y is formed on the supporting member 50, and the two side edges of the carrier 6 are adapted to slidably cooperate with the horizontal grooves 5a of the pair of supporting members 50, so that the carrier 6 can be supported on the pair of supporting members 50 and can slide along the horizontal groove 5a.

However, the present invention is not limited to the illustrated embodiments. For example, in another exemplary embodiment of the present invention, the carrier support frame 5 may be a transmission system with transmission and stopping functions, such as a transmission belt or transmission wheel transmission system, capable of transmitting and supporting the carrier 6.

The lower moving mechanism 2 includes a pair of lower longitudinal beams 21, a lower transverse beam 22, and a lower mounting bracket 25. The pair of lower longitudinal beams 21 extend along the longitudinal direction Y and are spaced opposite each other in the transverse direction X perpendicular to the longitudinal direction Y. The lower transverse beam 22 is installed at both ends on the pair of lower longitudinal beams 21, which can move along the longitudinal direction Y relative to the lower longitudinal beams 21. The lower mounting bracket 25 is mounted on the lower transverse beam 22 in a movable manner and can move along the transverse direction X relative to the lower transverse beam 22. The lower crimping module 4 is installed on the lower mounting bracket 25, so that the lower crimping module 4 can move along the longitudinal direction Y and the transverse direction X.

The lower moving mechanism 2 further comprises: two pairs of lower longitudinal sliding rails 21a and multiple lower longitudinal sliders 21b. Two pairs of lower longitudinal sliding rails 21a extend along the longitudinal direction Y and are respectively fixed to the pair of lower longitudinal beams 21. Multiple lower longitudinal sliders 21b are respectively slidably installed on two pairs of lower longitudinal sliding rails 21a, so as to be able to move along the lower longitudinal sliding rails 21a. The two ends of the lower transverse beam 22 are respectively fixed to multiple lower longitudinal sliders 21b, so that the lower transverse beam 22 can move along the lower longitudinal sliding rails 21a along with the lower longitudinal sliders 21.

The lower moving mechanism 2 further comprises a pair of lower longitudinal driving mechanisms 23, which are respectively installed on the pair of lower longitudinal beams 21 and connected to the lower transverse beam 22, for driving the lower transverse beam 22 to move along the longitudinal direction Y. The lower longitudinal driving mechanism 23 includes a pair of third support blocks 231, a third lead screw 232, a third nut 233, and a third servo motor 230. The pair of third support blocks 231 are fixed to the lower longitudinal beam 21. The two ends of the third lead screw 232 are respectively rotatably mounted on the pair of third support blocks 231. The third nut 233 is threaded with the third lead screw 232 and fixed to the lower transverse beam 22. The third servo motor 230 is installed on the lower longitudinal beam 21 and its output shaft is connected to one end of the third lead screw 232. When the third servo motor 230 drives the third lead screw 232 to rotate, the third lead screw 232 drives the third nut 233 and the lower transverse beam 22 to move along the longitudinal direction Y.

The lower moving mechanism 2 further comprises a pair of lower transverse sliding rails 22a and multiple lower transverse sliders 22b. The pair of lower transverse sliding rails 22a extend along the transverse direction X and are fixed to the lower transverse beam 22. Multiple lower transverse sliders 22b are respectively slidably installed on the pair of lower transverse sliding rails 22a, so as to be able to move along the lower transverse sliding rails 22a. The lower mounting bracket 25 is fixed to multiple lower transverse sliders 22b, allowing the lower mounting bracket 25 to move along the lower transverse sliding rail 22a along with the lower transverse sliders 22b.

The lower longitudinal beam 21 includes a lower longitudinal horizontal plate 210. The lower longitudinal sliding rail 21a, the lower longitudinal slider 21b, and the lower longitudinal driving mechanism 23 are installed on the lower longitudinal horizontal plate 210. The third lead screw 232 is located between the pair of lower longitudinal sliding rails 21a on the lower longitudinal horizontal plate 210.

The lower moving mechanism 2 further includes a lower transverse driving mechanism 24, which is installed on the lower transverse beam 22 and connected to the lower mounting bracket 25, for driving the lower mounting bracket 25 to move along the transverse direction X. The lower transverse driving mechanism 24 includes a pair of fourth support blocks 241, a fourth lead screw 242, a fourth nut 243, and a fourth servo motor 240. The pair of fourth support blocks 241 are fixed to the lower transverse beam 22. The two ends of the fourth lead screw 242 are respectively rotatably mounted on the pair of fourth support blocks 241. The fourth nut 243 is threaded with the fourth lead screw 242 and fixed to the lower mounting bracket 25. The fourth servo motor 240 is installed on the lower transverse beam 22 and its output shaft is connected to one end of the fourth lead screw 242. When the fourth servo motor 240 drives the fourth lead screw 242 to rotate, the fourth lead screw 242 drives the fourth nut 243 and the lower mounting bracket 25 to move together in the transverse direction X.

The lower transverse beam 22 includes a lower transverse horizontal plate 220, which is fixed to the lower longitudinal slider 21b and the third nut 233. The lower transverse sliding rail 22a, the lower transverse slider 22b, and the lower transverse driving mechanism 24 are installed on the lower transverse horizontal plate 220, and the fourth lead screw 242 is located between the pair of lower transverse sliding rails 22a on the lower transverse horizontal plate 220.

The lower mounting bracket 25 includes a lower mounting seat 250 and a lower vertical mounting plate 251. The lower mounting seat 250 is fixed to the lower transverse slider 22b and the fourth nut 243. The lower vertical mounting plate 251 is fixed to one side of the lower mounting seat 250, and the lower crimping module 4 is installed on the lower vertical mounting plate 251.

The upper crimping module 3 includes an upper seat body 30, an upper crimping mold 31, and a driving device (not shown). The upper seat body 30 is fixed to the upper mounting bracket 15. The upper crimping mold 31 is mounted on the upper seat body 30 in a movable manner. The driving device is installed on the upper seat body 30 and connected to the upper crimping mold 31. The driving device is used to drive the upper crimping mold 31 to move in the vertical direction Z, in order to crimp the terminal onto the flexible flat piece 7.

The lower crimping module 4 includes a lower seat body 40 and a lower crimping mold 41. The lower seat body 40 is fixed to the lower mounting bracket 25. The lower crimping mold 41 is installed onto the lower seat body 40. The lower crimping mold 41 is used to cooperate with the upper crimping mold 31 to crimp the terminal onto the flexible flat piece 7.

The crimping device further comprises two pairs of support posts 8, which are used to support the upper moving mechanism 1 and the lower moving mechanism 2. The two ends of one upper longitudinal beam 11 of the upper moving mechanism 1 are respectively fixed to one pair of support posts 8, and the two ends of the other upper longitudinal beam 11 are respectively fixed to the other pair of support posts 8. The two ends of one lower longitudinal beam 21 of the lower moving mechanism 2 are respectively fixed to one pair of support posts 8, and the two ends of the other lower longitudinal beam 21 are respectively fixed to the other pair of support posts 8.

The crimping device further includes a visual module 9, which is mounted on the upper mounting bracket 15 to move together with the upper crimping module 3. The upper crimping module 3 and the lower crimping module 4 are suitable for moving to the predetermined crimping position under the visual guidance of the visual module 9.

In another exemplary embodiment of the present invention, a crimping system is also disclosed. The crimping system includes the aforementioned crimping device, a carrier 6, and a carrier conveying mechanism (not shown). The carrier 6 is used to load a flexible flat piece 7. The carrier conveying mechanism is used to transport the carrier 6 loaded with the flexible flat piece 7 to the crimping device. The upper crimping module 3 and lower crimping module 4 of the crimping device are used to crimp the terminal onto the flexible flat piece 7.

The crimping system further comprises a terminal conveying mechanism (not shown) for conveying the terminals into the crimping device. After the crimping device completes terminal crimping, the carrier conveying mechanism transports the carrier 6 and the flexible flat piece 7 loaded on it and crimped with terminals to the next production station.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A crimping device, comprising:
an upper moving mechanism;
a lower moving mechanism arranged below the upper moving mechanism;
an upper crimping module installed on the upper moving mechanism and moving together with the upper moving mechanism;
a lower crimping module arranged below the upper moving mechanism and installed on the lower moving mechanism to move together with the lower moving mechanism; and
a carrier support frame supporting a carrier transported to the crimping device and a flexible flat piece loaded on the carrier, wherein:
the upper crimping module and the lower crimping module are adapted to crimp a terminal onto the flexible flat piece; and
the upper moving mechanism and the lower moving mechanism are adapted to horizontally move the upper crimping module and the lower crimping module respectively, with the upper crimping module and the lower crimping module synchronously movable to any crimping position on the flexible flat piece.

2. The crimping device according to claim 1, wherein an upper moving mechanism comprises:
a pair of upper longitudinal beams extending along a longitudinal direction and spaced opposite each other in a transverse direction perpendicular to the longitudinal direction;
an upper transverse beam having two ends mounted on the pair of upper longitudinal beams in a movable manner, and movable along the longitudinal direction relative to the upper longitudinal beams; and
an upper mounting bracket mounted on the upper transverse beam in a movable manner, and movable along the transverse direction relative to the upper transverse beam, wherein the upper crimping module is installed on the upper mounting bracket, so that the upper crimping module can move along the longitudinal direction and the transverse direction.

3. The crimping device according to claim 2, wherein the upper moving mechanism further comprises:
two pairs of longitudinal sliding rails extending along the longitudinal direction and respectively fixed on the pair of longitudinal beams;
multiple upper longitudinal sliders slidably installed on the two pairs of upper longitudinal sliding rails respectively, so as to be able to move along the upper longitudinal sliding rails; and
a pair of upper longitudinal driving mechanisms respectively installed on the pair of upper longitudinal beams and connected to the upper transverse beam, for driving the upper transverse beam to move along the longitudinal direction, wherein two ends of the upper transverse beam are respectively fixed to the multiple upper longitudinal sliders, so that the upper transverse beam can move along the upper longitudinal sliding rails together with the upper longitudinal sliders.

4. The crimping device according to claim 3, wherein the upper longitudinal driving mechanism comprises:
a pair of first support blocks fixed to the upper longitudinal beam;
a first lead screw, ends of which are rotatably mounted on the pair of first support blocks, respectively;
a first nut threaded with the first lead screw and fixed to the upper transverse beam; and
a first servo motor installed on the upper longitudinal beam and having an output shaft connected to one end of the first lead screw, wherein when the first servo motor drives the first lead screw to rotate, the first lead screw drives the first nut and the upper transverse beam to move together along the longitudinal direction.

5. The crimping device according to claim 4, wherein the upper moving mechanism further comprises:
a pair of upper transverse sliding rails extending along the transverse direction and fixed on the upper transverse beam; and
multiple upper transverse sliders respectively slidably installed on the pair of upper transverse sliding rails, so as to be able to move along the upper transverse sliding rails; and
an upper transverse driving mechanism installed on the upper transverse beam and connected to the upper mounting bracket, used to drive the upper mounting bracket to move along the transverse direction, wherein the upper mounting bracket is fixed to the multiple upper transverse sliders, so that the upper mounting bracket can move along the upper transverse rails together with the upper transverse sliders.

6. The crimping device according to claim 5, wherein the upper transverse driving mechanism comprises:
a pair of second support blocks fixed to the upper transverse beam;
a second lead screw, ends of which are rotatably mounted on the pair of second support blocks;
a second nut threaded with the second lead screw and fixed to the upper mounting bracket; and
a second servo motor installed on the upper transverse beam and having an output shaft connected to one end of the second lead screw, wherein when the second servo motor drives the second lead screw to rotate, the second lead screw drives the second nut and the upper mounting bracket to move together along the transverse direction.

7. The crimping device according to claim 6, wherein the upper transverse beam comprises:
an upper transverse horizontal plate fixed to the upper longitudinal slider and the first nut; and
an upper transverse vertical plate connected to one side of the upper transverse horizontal plate, wherein:
the upper transverse sliding rail, the upper transverse slider and the upper transverse driving mechanism are installed on the upper transverse vertical plate, and the second lead screw is located between the pair of upper transverse sliding rails on the upper transverse vertical plate; and
the upper mounting bracket comprises an upper vertical mounting plate fixed to the upper transverse slider and the second nut, wherein the upper crimping module is installed onto the upper vertical mounting plate.

8. The crimping device according to claim 2, wherein the carrier support frame comprises a pair of supporting members extending along the longitudinal direction and respectively fixed to the pair of upper longitudinal beams, wherein a horizontal groove extending along the longitudinal direction is formed on the supporting member, and the two side edges of the carrier are adapted to be slidably mated with the horizontal grooves of the pair of supporting members, so that the carrier can be supported on the pair of supporting members and can slide along the horizontal groove.

9. The crimping device according to claim 2, wherein the lower moving mechanism comprises:
a pair of lower longitudinal beams extending along the longitudinal direction and spaced opposite each other in a transverse direction perpendicular to the longitudinal direction;
a lower transverse beam, having ends respectively mounted on the pair of lower longitudinal beams in a movable manner, capable of moving along the longitudinal direction relative to the lower longitudinal beams; and
a lower mounting bracket mounted on the lower transverse beam in a movable manner, and can move along the transverse direction relative to the lower transverse beam, wherein the lower crimping module is installed on the lower mounting bracket, so that the lower crimping module can move along the longitudinal direction and the transverse direction.

10. The crimping device according to claim 9, wherein the lower moving mechanism further comprises:
two pairs of lower longitudinal sliding rails extending along the longitudinal direction and are respectively fixed on the pair of lower longitudinal beams;
multiple lower longitudinal sliders slidably installed on the two pairs of lower longitudinal sliding rails respectively, so as to be able to move along the lower longitudinal sliding rails; and
a pair of lower longitudinal driving mechanisms respectively installed on the pair of lower longitudinal beams and connected to the lower transverse beam, for driving the lower transverse beam to move along the longitudinal direction, wherein the two ends of the lower transverse beam are respectively fixed to the multiple lower longitudinal sliders, so that the lower transverse beam can move along the lower longitudinal sliding rails together with the lower longitudinal sliders.

11. The crimping device according to claim 10, wherein the lower longitudinal driving mechanism comprises:
a pair of third support blocks fixed to the lower longitudinal beam;
a third lead screw, having ends rotatably mounted on the pair of third support blocks;
a third nut threaded with the third lead screw and fixed to the lower transverse beam; and
a third servo motor installed on the lower longitudinal beam and having an output shaft connected to one end of the third lead screw, wherein when the third servo motor drives the third lead screw to rotate, the third lead screw drives the third nut and the lower transverse beam to move together along the longitudinal direction.

12. The crimping device according to claim 11, wherein the lower moving mechanism further comprises:
a pair of lower transverse sliding rails extending along the transverse direction and fixed on the lower transverse beam;
multiple lower transverse sliders slidably installed on the pair of lower transverse sliding rails respectively, so as to be able to move along the lower transverse sliding rails; and
a lower transverse driving mechanism installed on the lower transverse beam and connected to the lower mounting bracket, used to drive the lower mounting bracket to move along the transverse direction, wherein the lower mounting bracket is fixed to the multiple lower transverse sliders, so that the lower mounting bracket can move along the lower transverse sliding rails together with the lower transverse sliders.

13. The crimping device according to claim 12, wherein the lower transverse driving mechanism comprises:
a pair of fourth support blocks fixed to the lower transverse beam;
a fourth lead screw, having ends rotatably mounted on the pair of fourth support blocks;
a fourth nut threaded with the fourth lead screw and fixed to the lower mounting bracket; and
a fourth servo motor installed on the lower transverse beam and having an output shaft connected to one end of the fourth lead screw, wherein when the fourth servo motor drives the fourth lead screw to rotate, the fourth lead screw drives the fourth nut and the lower mounting bracket to move together along the transverse direction.

14. The crimping device according to claim 13, wherein:
the lower transverse beam comprises a lower transverse horizontal plate fixed to the lower longitudinal slider and the third nut, wherein the lower transverse sliding rail, the lower transverse slider, and the lower transverse driving mechanism are installed on the lower transverse horizontal plate, and the fourth lead screw is located between the pair of lower transverse sliding rails on the lower transverse horizontal plate; and
the lower mounting bracket comprises:
a lower mounting seat fixed to the lower transverse slider and the fourth nut; and
a lower vertical mounting plate fixed to one side of the lower mounting seat, wherein the lower crimping module is installed onto the lower vertical mounting plate.

15. The crimping device according to claim 1, wherein the upper crimping module comprises:
an upper seat body fixed to the upper mounting bracket;
an upper crimping mold installed on the upper seat body in a movable manner; and
a driving device installed on the upper seat body and connected to the upper crimping mold, wherein the driving device is used to drive the upper crimping mold to move in the vertical direction to crimp the terminal onto the flexible flat piece.

16. The crimping device according to claim 15, wherein the lower crimping module comprises:
a lower seat body fixed to the lower mounting bracket; and
a lower crimping mold installed onto the lower seat body, wherein the lower crimping mold is used to cooperate with the upper crimping mold to crimp the terminal onto the flexible flat piece.

17. The crimping device according to claim 9, further comprising two pairs of support posts supporting the upper moving mechanism and the lower moving mechanism, wherein:
two ends of one upper longitudinal beam of the upper moving mechanism are respectively fixed to one pair of support posts, and two ends of the other upper longitudinal beam are respectively fixed to the other pair of support posts; and
two ends of one lower longitudinal beam of the lower moving mechanism are respectively fixed to one pair of support posts, and two ends of the other lower longitudinal beam are respectively fixed to the other pair of support posts.

18. The crimping device according to claim 1, further comprising a visual module installed on the upper mounting bracket to move together with the upper crimping module, wherein the upper crimping module and the lower crimping module are adapted to move to the predetermined crimping position under the visual guidance of the visual module.

19. A crimping system, comprising:
the crimping device according to claim 1;
a carrier for loading a flexible flat piece; and
a carrier conveying mechanism for conveying the carrier loaded with the flexible flat piece to the crimping device.

20. The crimping system of claim 19, wherein the upper crimping module and lower crimping module of the crimping device are adapted to crimp a terminal onto the flexible flat piece.
